(19) United States
(12) Patent Application Publication
(10) Pub. No.: US 2010/0265789 A1
(43) Pub. Date: Oct. 21, 2010

(54) MULTI-COMPONENT SYSTEMS OPTIMISED FOR MIXING CONTROL

(75) Inventor: Klaus-Dieter Nehren, Dormagen (DE)

Correspondence Address: Hildebrand, Christa;Norris McLaughlin & Marcus PA, 875 Third Avenue, 8th Floor, New York, NY, 10022, US

(73) Assignee: HERAEUS KULZER GMBH, Hanay (DE)

(21) Appl. No.: 12/758,144

(22) Filed: Apr. 12, 2010

(30) Foreign Application Priority Data
Apr. 16, 2009 (DE) 10 2009 017 675.6

(51) Int. Cl. B01F 13/00

(52) U.S. Cl. 366/153.2

(57) ABSTRACT

An arrangements optimised for the mixing control of several components to be mixed by the user. The components include a paste A to be dispensed in a strand and another component B. A includes A1 which is white or a lightly coloured base paste and A2 is an intensely coloured colour paste. The components are within a container with a discharge aperture. Given stripes of A1 in A2 or of A2 in A1 are being arranged or A1 and A2 are stored separately and, at the discharge aperture, a device for producing stripes of A1 in A2 or of A2 in A1 is provided such that A1 and A2 together result in a stripe pattern in the discharged strand which is provided for mixing with at least one further component B.

### BACKGROUND OF THE INVENTION

(1) Field of the Invention

The invention relates to multi-component systems optimised for mixing control.

(2) Description of Related Art

For the so-called self-hardening/chemically hardening multi-component systems such as impression materials, adhesives, prosthesis materials, facing materials or composites, the user mixes at least two components. Divided into the various liquid components or those in paste form, the materials contain substances such as wetting agents, activators, catalysts and/or inhibitors which, on mixing, initiate a more or less rapid polymerisation reaction leading to the formation of elastomers or plastics.

To achieve the desired elastomer and/or polymer properties, thorough and homogeneous mixing is required.

In the case of two-component systems which are sold in dual cartridges or comparable containers and are mixed automatically during metering also by means of static or dynamic mixers, a sufficient mixing quality can be assumed to be usually present.

However, multi-component systems sold in individual containers such as tubes or cartridges must be mixed by hand e.g. with a spatula. In the case of dental impression materials, the components are often differently coloured in order to provide the user with an optical mixing control.

In the case of condensation-crosslinking silicone impression compounds, in particular, it is common practice to offer a single universal activator liquid or paste for many multicoloured base pastes.

This has the advantage that the user needs to store fewer components. Even more important is the fact in the case of these systems that it is possible for the user to adjust the material individually to the processing time required by him and appropriate for the situation concerned, by varying the dosage ratios.

However, this universal activator has the disadvantage that its colour must influence the mixing colour only slightly. This means that the mixing control is simultaneously reduced.

At present it is hardly possible for the customer in the case of certain multi-component systems to determine by the colour whether satisfactory mixing has taken place. This leads to loss of time as one tends to mix rather too thoroughly. If this is not done, a complaint may result accusing the product of being inadequate and thorough technical application advice is required to solve the “user problem”.

To avoid the disadvantages described, the task arises of achieving a good mixing control particularly for systems in the case of which the universal activator/catalyst (liquid and paste) continues to be lightly coloured and thus the mixing colour in combination with all the different base paste colours being influenced only slightly.

### BRIEF SUMMARY OF THE INVENTION

The object is achieved by at least one of the two components, preferably the base paste, being multicoloured on packaging, preferably in tubes.

Two methods have been well-established for years in order to produce stripes, particularly in tooth paste.
1. The tube contains an insert which keeps the base paste separate from the colour paste. Through small holes in this insert, a stripe of colour paste is produced during discharging on the outside of the paste strand. In this way, it is possible to add a colour paste. Packaging takes place in two stages. First, the colour paste is introduced into the insert and on top of it the base paste.
2. The newer and more flexible method of introducing several different colour stripes simultaneously into the paste consists of using an entirely normal tube in which the stripes are produced in the tube itself in a filling process using a special filling nozzle.

During delivery and metering of the paste filled into the tube in several colours, the user obtains in a manner analogous to tooth paste a preferably white/whitish base paste with intensely coloured stripes. The relatively lightly coloured activator is then metered in and still provides a clear contrast to the white base paste.

During subsequent mixing of these two components which, however, are tricoloured, the intense colour stripes ensure that the user has excellent control of the quality of mixing. The mixing colours can be adjusted in the same way as they have always been such that the user is confronted by the accustomed result.

Obviously, it is also possible to equip systems according to the invention to be multicoloured and not to exhibit the above-mentioned universal component.

### DETAILED DESCRIPTION OF THE INVENTION

The obvious advantages of the invention are:

The user/customer, as a rule the dentist or his/her assistant, can simply recognise without additional effort, when sufficient mixing has been carried out.

A further advantage for the production is that the base pastes can be produced entirely without coloration, which reduces the cleaning effort when changing the product considerably. Colouring takes place only on introducing the precursor for the coloured stripe.

Special tubes with the corresponding inserts can be use as primary packaging. It is advantageous to produce the stripes in the packaging using special nozzles. In this way, it is also possible to produce several different colour stripes. In addition, this technique can be used with entirely standard tubes or also for cartridges, syringes or single use packaging such as sealed edge bags or tins.

Thus, an arrangement is provided that is optimised for the mixing control of several components to be mixed by the user. It includes a paste A which is to be dispensed in a strand and at least one further component B. Past A includes A1, a white or lightly coloured base paste and A2 which is at least one intensely coloured colour paste. The base paste and the coloured past are contained in a container with a discharge aperture. The given stripes of A1 in A2 or of A2 in A1 are arranged or A1 and A2 are stored separately and, at the discharge aperture, a device for producing stripes of A1 in A2 or of A2 in A1 is provided such that A1 and A2 together result in a stripe pattern in the discharged strand which is provided for mixing with at least one further component B.

Further, a process is disclosed for a mixing control of a multi-component system to be mixed by the user of a paste A to be dispensed as a strand and at least one further component B. A including A1 a white or lightly coloured base paste and A2 an intensely coloured colour paste and A1 and A2 together provide a stripe pattern in the discharged strand and the strand is mixed with at least one further component B until the user observes a homogeneously coloured mixture. The colours of component A1 are of any light colour, white or ivory. The colour paste A2 is present in several differently coloured parts.

1. An arrangement for optimizing a mixing control of several components to be mixed by a user, comprising
a paste A to be dispensed in a strand and at least one further component B,
A comprising A1 a white or lightly coloured base paste and
A2 at least one intensely coloured colour paste,
wherein in a container with a discharge aperture, stripes of A1 in A2 or of A2 in A1 are arranged, or A1 and A2 are stored separately and, at the discharge aperture, a device for producing stripes of A1 in A2 or of A2 in A1 is provided such that A1 and A2 together result in a stripe pattern in the discharged strand which is provided for mixing with at least one further component B.

2. A process for mixing control of a multi-component system to be mixed by the user of a paste A to be dispensed as a strand and at least one further component B, A comprising the steps of
providing A1 a white or lightly coloured base paste and
providing A2 an intensely coloured colour paste,
wherein A1 and A2 together provide a stripe pattern in the discharged strand, and mixing the strand with at least one further component B until a homogenized coloured mixture is obtained.

3. An arrangement according to claim 1, wherein the component A1 is one of a light colour, white, light grey or ivory.

4. An arrangement according to claim 2, wherein the colour paste A2 is provided by several differently coloured parts.
